(19) United States
(12) Patent Application Publication
(10) Pub. No.: US 2026/0087360 A1
(43) Pub. Date: Mar. 26, 2026

(54) TRAINING DEVICE, HANDLING SYSTEM, TRAINING METHOD, AND STORAGE MEDIUM

(71) Applicant: KABUSHIKI KAISHA TOSHIBA, Kawasaki-shi (JP)

(72) Inventors: Kazuma KOMODA, Yokohama (JP); Junichiro OOGA, Kawasaki (JP); Ping JIANG, Kawasaki (JP); Haifeng HAN, Yokohama (JP)

(73) Assignee: KABUSHIKI KAISHA TOSHIBA, Kawasaki-shi (JP)

(21) Appl. No.: 19/326,169

(22) Filed: Sep. 11, 2025

(30) Foreign Application Priority Data
Sep. 20, 2024 (JP) 2024-164181

(51) Int. Cl. G06N 3/092; B25J 9/16

(52) U.S. Cl. CPC G06N 3/092; B25J 9/163; B25J 9/1697

(57) ABSTRACT

According to one embodiment, a training device is configured to perform first to third training. The first training includes training a first policy in a simulation environment, the first policy being configured to determine a gripping operation of a robot arm including a gripper. The second training includes training a second policy in a real environment, the second policy being configured to determine the gripping operation of the robot arm. The third training includes training a model configured to output, according to an input of an image, grip information for gripping an object. The second training includes training the second policy by using an output from the first policy and sensor information acquired in the gripping operation. The third training includes training the model by using, as teaching data, a first image of a first environment of reality and grip information output from the second policy.

### CROSS-REFERENCE TO RELATED APPLICATIONS

This application is based upon and claims the benefit of priority from Japanese Patent Application No. 2024-164181, filed on Sep. 20, 2024; the entire contents of which are incorporated herein by reference.

### FIELD

Embodiments of the invention generally relate to a training device, a handling system, a training method, and a storage medium.

### BACKGROUND

There is a handling robot that transfers or picks objects. There is a need for handling robot technology that can reduce training costs.

### BRIEF DESCRIPTION OF THE DRAWINGS

FIG. 1 is a perspective view showing an example of a handling system according to an embodiment;

FIG. 2 is a schematic view showing a training method of a training device according to the embodiment;

FIG. 3 is a flowchart showing processing of a first training;

FIG. 4 is a schematic view showing the flow of data in the first training;

FIG. 5 is a flowchart showing processing of a second training;

FIG. 6 is a schematic view showing the flow of data in the second training;

FIG. 7 is a flowchart showing processing of a third training;

FIG. 8 is a flowchart showing a handling method that uses a trained model;

FIG. 9 is a flowchart illustrating a processing method of sensor information;

FIG. 10 is a schematic view showing the processing method shown in FIG. 9; and

FIG. 11 is a schematic view illustrating a hardware configuration.

### DETAILED DESCRIPTION

According to one embodiment, a training device is configured to perform at least a first training, a second training, and a third training. The first training includes training a first policy in a simulation environment, the first policy being configured to determine a gripping operation of a robot arm including a gripper. The second training includes training a second policy in a real environment, the second policy being configured to determine the gripping operation of the robot arm. The third training includes training a model configured to output, according to an input of an image, grip information for gripping an object. In the training device, the second training includes training the second policy by using an output from the first policy that is trained, and sensor information acquired by a sensor in the gripping operation. In the training device, the third training includes training the model by using, as teaching data, a first image of a first environment of reality, and grip information output from the second policy that is trained for the first environment.

Embodiments of the invention will now be described with reference to the drawings. The drawings are schematic or conceptual; and the relationships between the thicknesses and widths of portions, the proportions of sizes between portions, etc., are not necessarily the same as the actual values thereof. The dimensions and/or the proportions may be illustrated differently between the drawings, even in the case where the same portion is illustrated. In the drawings and the specification of the application, components similar to those described thereinabove are marked with like reference numerals, and a detailed description is omitted as appropriate.

A handling robot that transfers or picks objects is used in a logistics site. The handling robot includes an articulated robot arm, and includes a gripper located at the distal end of the robot arm. The gripper can grip an object by suction-gripping or pinching.

When the robot arm grips the object, grip information that is necessary for the gripping operation is calculated. For example, object recognition, gripping point calculation, plan generation, etc., are performed. In recent years, machine-learned models are being used to calculate such grip information in a shorter period of time. By using the models, the grip information can be acquired in a shorter period of time, and the start of the operation of the robot arm can be earlier. The handling robot can be efficiently utilized thereby.

On the other hand, it takes an enormous amount of data and training time to train a model. When the gripper is changed or a feature of the object to be gripped changes, it is necessary to update the model. “Update” is the retraining of the model or the replacement of the model. Updating the model again requires data and time for the training.

Herein, the data necessary for the training and the time necessary for the training are called the “training cost”. As described above, using a model to acquire grip information requires a considerable training cost beforehand. Training costs also are incurred when updating the model. Embodiments of the invention are directed to technology that can reduce the training cost.

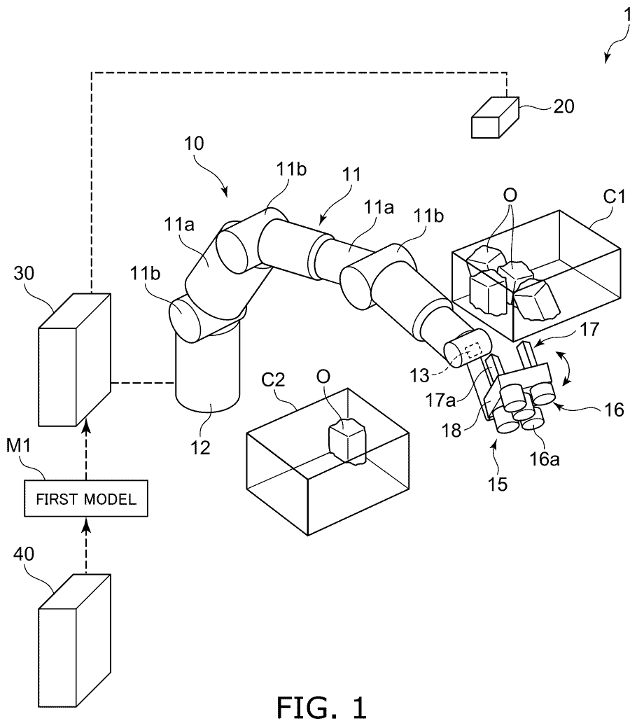

FIG. 1 is a perspective view showing an example of a handling system according to an embodiment.

The handling system 1 shown in FIG. 1 handles objects by using a trained model. Specifically, the handling system 1 includes a handling robot 10, a sensor 20, and a processing device 30.

The handling robot 10 includes a robot arm 11 and a base part 12. The robot arm 11 includes multiple links 11a and multiple rotation axes 11b. The links 11a are coupled to each other by the rotation axes 11b. In the illustrated example, the robot arm 11 is vertical articulated. The robot arm 11 may be horizontal articulated.

The position and posture (angle) of the distal end of the robot arm 11 is changed by operating the rotation axes 11b. It is favorable for the distal end of the robot arm 11 to have six degrees of freedom. A gripper 15 is mounted to the distal end of the robot arm 11. In the illustrated example, the gripper 15 includes a suction mechanism 16 and a pinching mechanism 17.

The suction mechanism 16 grips the object by suction-gripping. The suction mechanism 16 includes one or more suction pads 16a. The interior of the suction pad 16a is decompressed by a depressurizing apparatus (not illustrated) in a state in which the suction pad 16a contacts the object. As a result, the suction pad 16a suction-grips the object. The number of the suction pads 16a may be less than or more than that of the illustrated example.

The pinching mechanism 17 grips the object by pinching. The pinching mechanism 17 includes multiple rod-shaped supporters 17a. The object is gripped by being pinched by the multiple supporters 17a. The pinching mechanism 17 may include more supporters 17a than in the illustrated example. The supporter 17a may be configured in finger shapes including one or more joints.

The gripper 15 also includes a switching mechanism 18. The suction mechanism 16 and the pinching mechanism 17 are coupled to the switching mechanism 18. The switching mechanism 18 rotates the suction mechanism 16 and the pinching mechanism 17. The mechanism that is used to grip the object can be switched by rotating the suction mechanism 16 and the pinching mechanism 17.

The gripper 15 is not limited to the illustrated example and may include only one of the suction mechanism 16 or the pinching mechanism 17. In such a case, the switching mechanism 18 is unnecessary.

The robot arm 11 also includes a sensor 13. The sensor 13 can detect at least one selected from the group consisting of a load applied to the gripper 15, a torque applied to the gripper 15, the acceleration of the gripper 15, and the angular velocity of the gripper 15. For example, the sensor 13 includes at least one selected from the group consisting of a force sensor, an acceleration sensor, and an angular velocity sensor.

Two containers C1 and C2 are placed proximate to the handling robot 10. The handling robot 10 grips an object O contained in the container C1 and transfers the object O to the container C2.

The sensor 20 is provided to detect the state inside the container C1. For example, the sensor 20 includes at least one selected from an image sensor and a depth sensor. The sensor 20 may be fixed above the container C1 or may be mounted to the handling robot 10.

The processing device 30 acquires an image acquired by the sensor 20. The processing device 30 refers to a first model M1. The first model M1 outputs, according to the input of the image, grip information for gripping the object. The “grip information” includes, for example, the gripping point. The gripping point indicates the position and posture (angle) of the gripper 15 when gripping the object. The grip information also may include information of the type of the gripper 15. When multiple objects are present in the container C1 and the multiple objects are sequentially transferred, the grip information may include the gripping points of the objects and the transfer 25 sequence.

By inputting the image to the first model M1, the processing device 30 acquires grip information for gripping the object visible in the image. The robot arm 11 grips the object by operating according to the grip information.

The first model M1 is pretrained by a training device 40. The handling system 1 may include the training device 40. The processing device 30 may function as the training device 40.

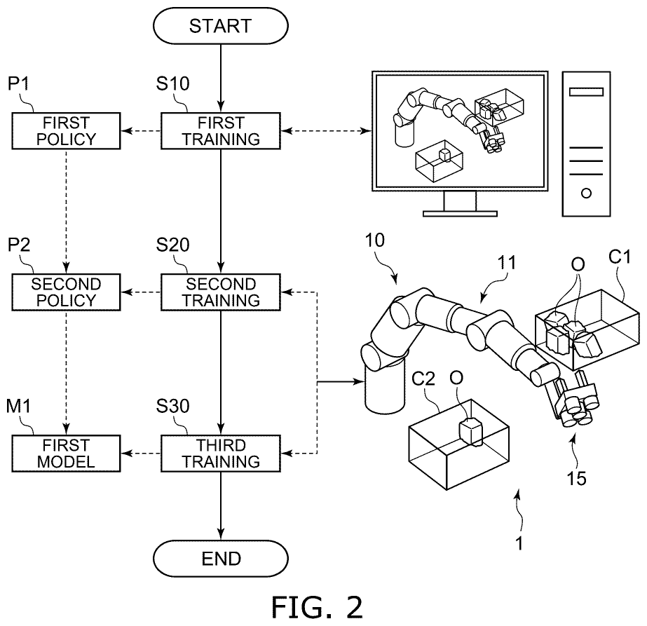

FIG. 2 is a schematic view showing a training method of the training device according to the embodiment.

The training device according to the embodiment performs the training method shown in FIG. 1. The training method includes a first training (step S10), a second training (step S20), and a third training (step S30).

In the first training (step S10), the training device trains a first policy P1. The first policy P1 is rules for determining the gripping operation of the robot arm. The first policy P1 is trained in a simulation environment by using a computer. The first policy P1 is trained to improve the success rate of the gripping of the robot arm.

In the second training (step S20), the training device trains a second policy P2. The second policy P2 is rules for determining the gripping operation of the robot arm. The second policy P2 is trained in a real environment by using the actual robot arm. Information related to the robot arm, sensor information acquired by a sensor, output from the first policy P1, etc., are used to train the second policy P2. The second policy P2 is trained to improve the success rate of the gripping of the robot arm.

In the third training (step S30), the training device trains the first model M1. The first model M1 outputs, according to the input of an image, grip information for gripping the object. An image (a first image) of a real environment (a first environment), output from the second policy P2, etc., are used to train the first model M1. The first model M1 is trained to improve the success rate of the gripping of the robot arm.

A simulation environment is used in the first training. Training that uses a simulation environment is easier than training that uses a real environment; and the training cost can be reduced. A real environment is used in the second training. By using the trained first policy in such a case, the training of the second policy can be faster, and the training cost can be reduced. The output of the trained second policy is used in the third training. By using the second policy to prepare high-quality training data, the training of the first model M1 can be faster, and the training cost can be reduced.

Specific examples of the training will now be described. An example will now be described in which reinforcement learning is used in the training.

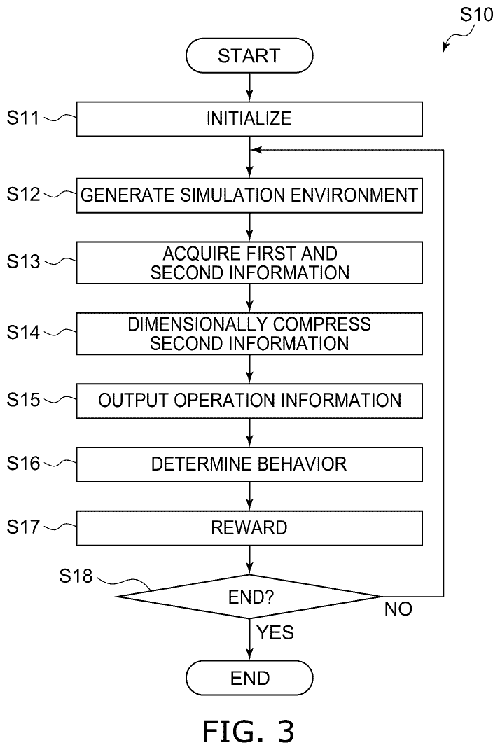

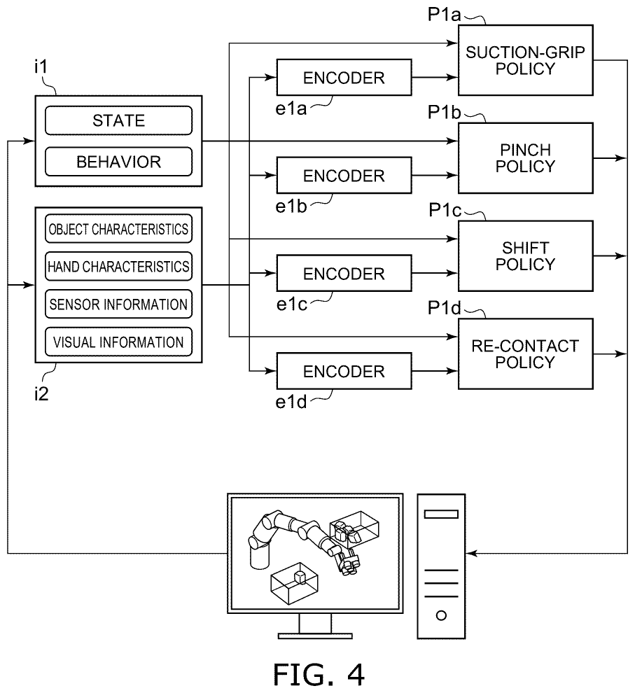

FIG. 3 is a flowchart showing processing of the first training. FIG. 4 is a schematic view showing the flow of data in the first training.

In the first training, first, the simulation environment and the state of the robot arm (the agent) are initialized in the simulator (step S11). Then, a simulation environment is generated (step S12). The simulation environment is generated and stored by a user. For example, the simulator can use a physics engine such as Bullet, etc. Robot visualization tools such as rviz, etc., also can be used in the simulation. Sensor information of the robot, the state of the robot, a three-dimensional model of the environment, etc., can be displayed by using a visualization tool. The simulation environment is generated to model the environment of the handling robot 10 in reality.

Reinforcement learning is performed using the generated simulation environment. Specifically, the training device acquires first information i1 and second information i2 (shown in FIG. 4) of the simulation environment (step S13).

The first information i1 includes at least one selected from the group consisting of information of the state of the robot arm 11, information of the state of the periphery of the robot arm 11, and information of the behavior of the robot arm 11. For example, “the state of the robot arm” includes whether or not the object is being gripped, the position and posture of the gripper 15, the position and posture of the robot arm 11, etc. For example, the position and posture of the robot arm 11 and the position and posture of the gripper 15 can be represented by a combination of the rotation angles of the axes (the motors). “The state of the periphery of the robot arm” includes how many objects are in the container, the arrangement state of the objects in the container, the presence of partitions in the container, etc. “The behavior of the robot arm” includes picking, shifting an object, etc.

The second information i2 includes at least one selected from the group consisting of information of a characteristic of the object O to be gripped, information of a characteristic of the gripper 15 (the robot hand), sensor information, and image information of the object O. The sensor information is acquired by the sensor 13. The image information is acquired by the sensor 20.

Multiple first strategies P1a to Pd are trained in the example shown in FIG. 4. The first policy P1a is related to the operation of the robot arm 11 when gripping the object by suction. The first policy P1a outputs grip information for the robot arm 11 to suction-grip the object. When the output of the first policy P1a is employed as the plan, the robot arm 11 attempts to suction-grip the object according to the grip information output from the first policy P1a.

The first policy P1b is related to the operation of the robot arm 11 when gripping the object by pinching. The first policy P1b outputs grip information for the robot arm 11 to pinch the object. When the output of the first policy P1b is employed as the plan, the robot arm 11 attempts to pinch the object according to the grip information output from the first policy P1b.

The first policy P1c is related to the operation of the robot arm 11 before gripping the object. As an example, multiple thin objects are placed upright inside the container C1. When any one object is gripped by suction, the contact area between the gripper 15 and the object O is small; and it is difficult to grip by suction. In such a case, it is effective for the gripper 15 to contact the object and knock over (shift) the object. By knocking over the object, a larger surface of the object is caused to face upward. The success rate of the gripping is increased by suction-gripping a large surface. When the output of the first policy P1c is employed as the plan, the robot arm 11 attempts to shift the object according to the operation information output from the first policy P1c.

The first policy P1d is related to the operation of the robot arm 11 after attempting to grip the object. As an example, the gripper 15 grips a cylindrical or circular object. The object may rotate when the gripper 15 contacts the object. The contact state between the gripper 15 and the object changes when the object rotates. For example, the success rate of the gripping decreases as the contact area between the gripper 15 and the object decreases. When the contact state has changed or when the gripping has failed, the gripper 15 can be separated once from the object and then brought into contact again, thereby increasing the success rate of the gripping. When the output of the first policy P1d is employed as the plan, the robot arm 11 attempts to cause the gripper 15 to re-contact the object according to the operation information output from the first policy P1d.

The first information i1 and the second information i2 are input to the first strategies P1a to P1d. The first strategies Pla to P1d output the operation information of the robot arm 11 according to the input of the information.

In the illustrated example, the second information i2 is dimensionally compressed by the encoders e1a to e1d (step S14). The first information i1 and the dimensionally-compressed second information i2 are input to the first strategies P1a to P1d. The second information i2 also includes information that is not important to determine the operation. The encoding can increase the versatility of the first strategies P1a to P1d by abstracting the information of the second information i2. The first information i1 is input to the first strategies P1a to P1d without passing through an encoder because the first information i1 includes little or no unnecessary information.

The encoders e1a to e1d may be the same or different from each other. Favorably, the encoders e1a to e1d are different from each other so that dimensional compression that is respectively suited to the first strategies P1a to P1d is realized. The encoders e1a to e1d include, for example, variational autoencoders (VAEs), convolutional autoencoders (CAEs), etc. A generative adversarial network (GAN) may be combined with a VAE.

The operation information is output by the first strategies P1a to P1d when the first information i1 and the second information i2 are input to the first strategies P1a to P1d (step S15). For example, the first strategies P1a to P1d output the position and posture of the gripper 15 when performing the operations.

The training device 40 employs any of the operation information output from the first strategies P1a to Pd, and determines the behavior based on the operation information (step S16). For example, the training device 40 generates a plan based on the operation information, the first information, and the second information. The plan includes the object to be transferred, the position and posture of the gripper 15 when gripping the object, the transit positions, the position and posture of the gripper 15 when releasing the object, the grip force of the gripper 15, the gripping technique of the object, the transfer speed, etc. When the object is gripped by suction, the grip force is expressed in terms of pressure (degree of vacuum). When the object is gripped by pinching, the grip force is expressed in terms of motor current.

The training device 40 operates the robot arm 11 in the simulation environment according to the behavior determined in step S16. When the intended result is obtained, the training device 40 returns a reward to the first policy that output the employed operation information (step S17). For example, the behavior is determined based on the output from the suction-grip or pinch policy; and a reward is provided to the suction-grip or pinch policy when suction-gripping or pinching is successful. The behavior is determined based on the output from the shift policy; and a reward is provided to the shift policy when the shifting is successful or the gripping is successful after the shifting operation. The behavior is determined based on the output from the re-contact policy; and a reward is provided to the re-contact policy when the gripping is successful after re-contacting. The first strategies P1a to Pd are trained to maximize the reward.

After the training has been performed in the simulation environment generated in step S12, the training device 40 determines whether or not to end the training (step S18). For example, the training device 40 ends the first training when the cumulative reward or the average reward obtained by the agent exceeds a preset threshold within a certain period of time. Or, the training device 40 ends the first training when the training has been performed in a preset number of simulation environments.

When the training is continued, the training device 40 acquires the next simulation environment and re-performs steps S12 to S17 using the next simulation environment.

One or more first strategies are trained by the processing described above. The training device 40 stores the trained first strategies.

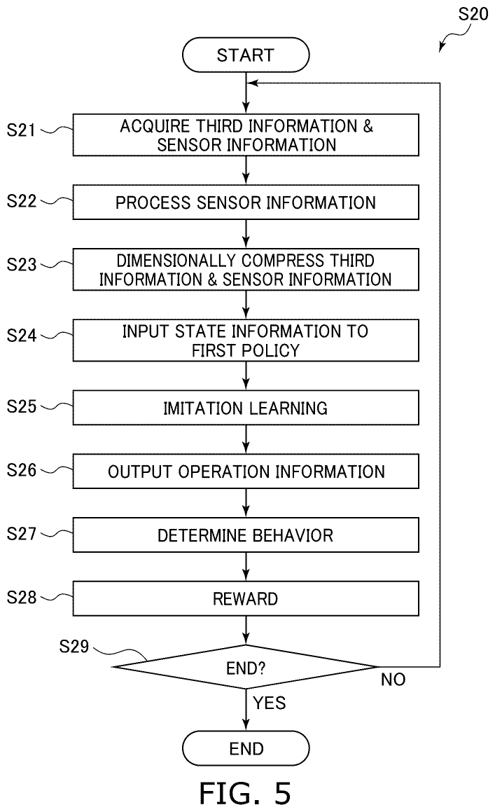

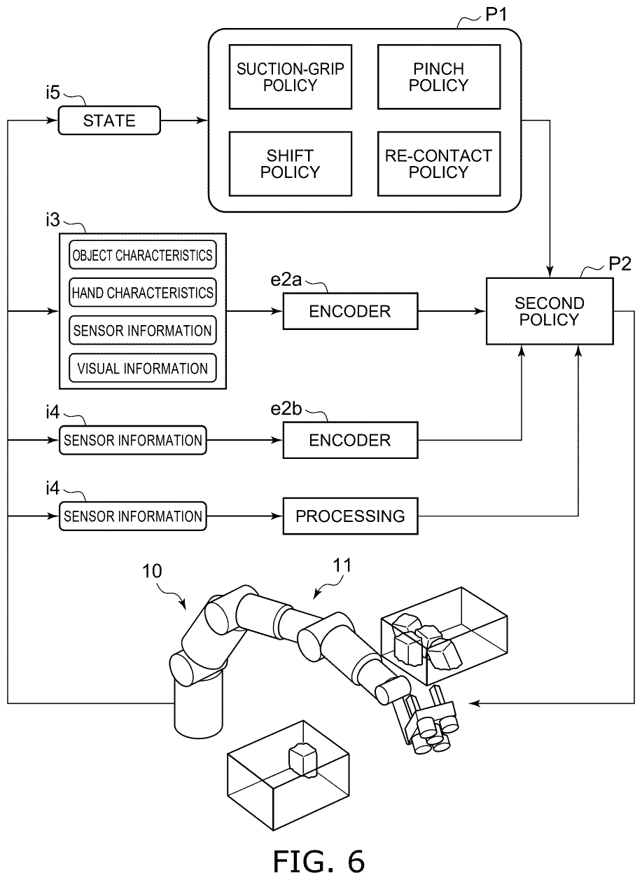

FIG. 5 is a flowchart showing processing of the second training. FIG. 6 is a schematic view showing the flow of data in the second training.

In the second training as shown in FIG. 5, third information i3 and sensor information i4 (shown in FIG. 6) are acquired (step S21). Similarly to the second information i2, the third information i3 includes at least one selected from the group consisting of information of a characteristic of the object O to be gripped, information of a characteristic of the gripper 15 (the robot hand), sensor information, and image information of the object O. The sensor information i4 includes information acquired by a sensor of the handling system 1 in reality. The sensor information i4 includes a load applied to the gripper 15, a torque applied to the gripper 15, the acceleration of the gripper 15, the angular velocity of the gripper 15, the rotation angle of a motor included in the robot arm 11, the rotational speed of the motor, contact information between the gripper 15 and the object, an image of the handling robot 10, etc. The sensor information i4 may include multiple consecutive images (a video image).

The training device 40 processes the sensor information i4 (step S22). For example, the processing removes noise included in the sensor information i4. Or, the sensor information i4 is abstracted for the training.

The training device 40 performs dimensional compression by inputting the third information i3 and the sensor information i4 respectively to the encoders e2a and e2b (step S23). The training device 40 also inputs, to the first policy, state information i5 of the robot arm 11 in reality (step S24). The state information i5 includes at least one selected from the group consisting of information of the state of the robot arm 11 and information of the state of the periphery of the robot arm 11.

The training device 40 causes the second policy to perform imitation learning by using the dimensionally-compressed third information i3, the dimensionally-compressed sensor information i4, the processed sensor information i4, and the output from the first policy (step S25). The output of the first policy may be acquired from an output layer of the first policy. Or, a latent vector of an intermediate layer of the first policy between the input layer and the output layer may be extracted as the output of the first policy. The output of the first policy may be distilled and used to train the second policy. In the imitation learning, the second policy is trained so that the output of the second policy imitates the output of the first policy when the third information i3 and the sensor information i4 are input. In the example shown in FIG. 6, outputs are obtained from multiple first strategies. These outputs may be averaged or used as a weighted average.

Instead of the example shown in FIG. 6, the sensor information i4 may be processed and then dimensionally compressed. In such a case, the imitation learning of the second policy is performed using the dimensionally-compressed third information i3, the processed and dimensionally compressed sensor information i4, and the output from the first policy.

The trained second policy P2 outputs the operation information of the robot arm 11 (step S26). The training device 40 determines the behavior of the robot arm 11 based on the output of the second policy P2 (step S27). The training device 40 operates the robot arm 11 in the real environment according to the behavior determined in step S26. When the intended results are obtained, the training device 40 returns a reward to the second policy (step S28). The second policy P2 is trained to maximize the reward.

The training device 40 determines whether or not to end the training (step S29). For example, the training device 40 ends the second training when the cumulative reward or average reward obtained by the agent exceeds a preset threshold within a certain period of time. Or, the training device 40 ends the second training when the imitation learning is performed a preset number of times.

When the training is continued, the next real environment is prepared. The training device 40 re-performs steps S21 to S28 in the next real environment.

The second policy is trained by the processing described above. The training device 40 stores the trained second policy.

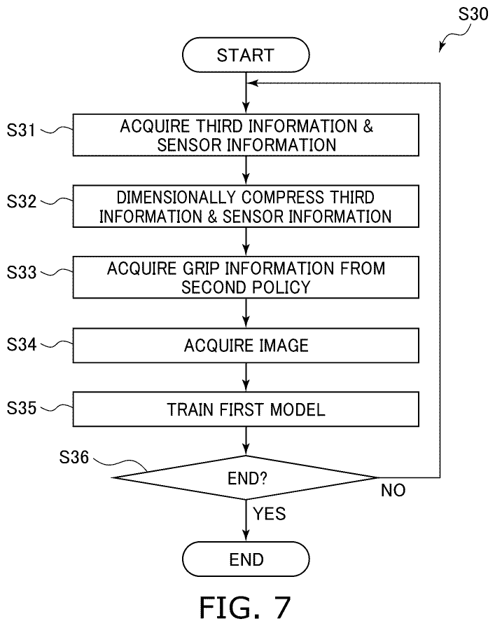

FIG. 7 is a flowchart showing processing of the third training.

In the third training as shown in FIG. 7, third information and sensor information are acquired in a real environment (step S31). The training device 40 dimensionally compresses the information (step S32) and inputs the information to the second policy. The training device 40 acquires grip information output from the second policy (step S33). The training device 40 also acquires an image of the real environment acquired by the sensor 20 (step S34). The training device 40 sets the image in the input layer, sets the grip information from the second policy in the output layer, and trains the model with supervised learning (step S35).

The training device 40 determines whether or not to end the training (step S36). For example, the training device 40 ends the third training when the loss of the trained model is less than a preset threshold. Or, the training device 40 ends the third training when the training is performed a preset number of times. When the training is continued, the next real environment is prepared. The training device 40 re-performs steps S31 to S35 in the next real environment.

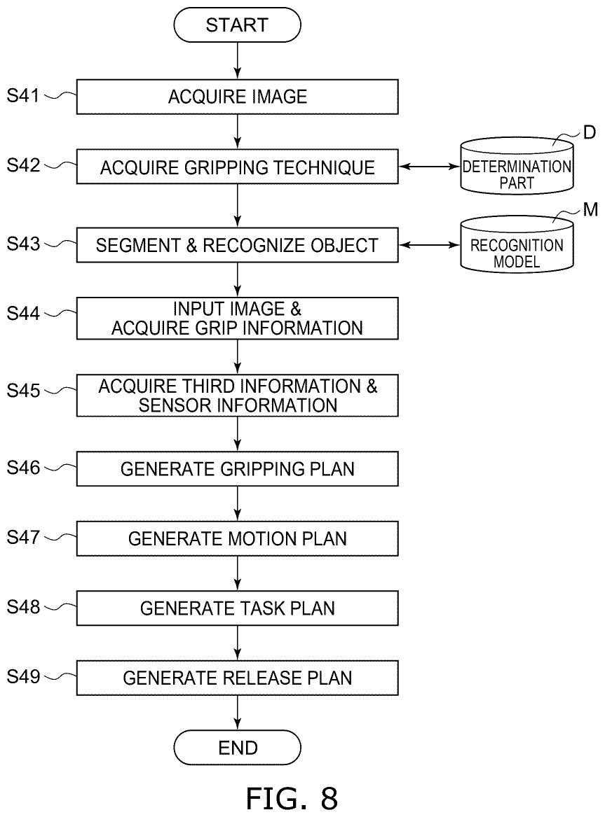

The model for outputting the grip information is trained by the processing described above. After the training of the model is completed, the model is used to acquire the grip information. FIG. 8 is a flowchart showing a handling method that uses the trained model.

After completing the training, the processing device 30 causes the handling robot 10 to grip the object by using the trained first model M1. Specifically, as shown in FIG. 8, the processing device 30 acquires an image acquired by the sensor 20 (step S41).

The processing device 30 inputs the image to a determination part D, and acquires a gripping technique output from the determination part D (step S42). The determination part D outputs, according to the input of the image, a determination result as to which gripping technique among suction-gripping or pinching should be used. The determination part D is machine-learned beforehand. For example, the determination part D includes a neural network. Favorably, the determination part D includes a convolutional neural network (CNN).

The processing device 30 uses the image to segment and recognize the object (step S43). The segmentation and the recognition are performed by a trained recognition model. For example, the recognition model includes a neural network. Favorably, a recognition model M includes a CNN. The recognition model M outputs an image of the recognition result.

The processing device 30 inputs the image output from the recognition model M to the trained first model M1, and acquires grip information output from the first model M1 (step S44).

The processing device 30 also acquires the third information and sensor information (step S45). The processing device 30 generates various plans based on the information. The plan generation includes gripping plan generation (step S46), motion plan generation (step S47), task plan generation (step S48), and release plan generation (step S49). The gripping plan includes the position and posture of the gripper 15 when gripping the object, the gripping technique, the grip force, etc. The motion plan includes the movement of the gripper 15 when gripping the object, the movement of the object to be gripped, etc. The task plan includes the via-points of the gripper 15 from the gripping of the object to the release of the object. The release plan includes the position and posture of the gripper 15 when releasing the object.

Advantages of embodiments will now be described.

According to embodiments of the invention, the first training, the second training, and the third training are performed. In the first training, the first policy for determining the gripping operation of the robot arm 11 is trained in a simulation environment. By training in the simulation environment, the first policy can be trained in a shorter period of time compared to training in a real environment. In the second training, the second policy is trained in a real environment. The training uses sensor information acquired by a sensor in the gripping operation and the output from the trained first policy. The first policy is sufficiently trained in the simulation environment. Therefore, the output from the first policy can be utilized as high-quality training data. The time necessary to train the second policy can be reduced by utilizing the output from the first policy in the training. The time necessary to train the second policy can be further reduced by using the sensor information of the real environment in the training. In the third training, a model that outputs grip information based on an image is trained. The second policy is sufficiently trained in the real environment. Therefore, the output from the second policy can be utilized as high-quality training data. The time necessary to train the model can be reduced by utilizing the output from the second policy in the training.

According to embodiments, the cost necessary to train the model for obtaining the grip information can be reduced.

The sensor information may be used to train the second policy by any technique. Specific examples when the sensor information includes force information of time-series data will now be described. The force information includes at least one selected from the group consisting of a load, a torque, an acceleration, and an angular velocity.

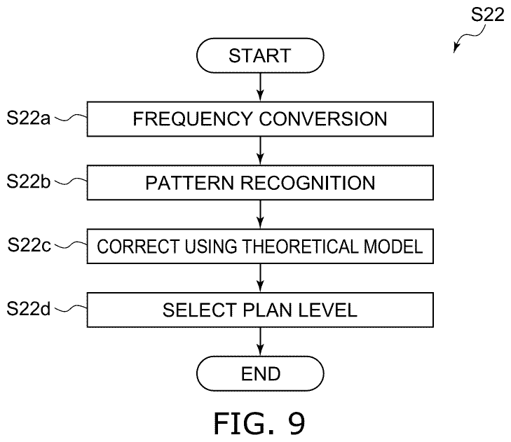

FIG. 9 is a flowchart illustrating a processing method of the sensor information.

FIG. 9 shows a specific example of step S22 of FIG. 5. First, the training device 40 performs frequency conversion of the force information (step S22a). The frequency conversion can include fast Fourier transform (FFT). By performing the frequency conversion, noise that is unnecessary for the training is removed.

Then, the training device 40 patternizes the time-series data (step S22b). By patternizing, the time-series data is subdivided into multiple intervals, and it is determined which operation is being performed in each interval of the time-series data. The k-means algorithm can be used in the patternizing.

The training device 40 uses a theoretical model prepared beforehand to correct the patternized time-series data (step S22c). The correction includes at least one selected from the group consisting of comparing with a threshold, filtering, and integrating a stiffness matrix. For example, faint noise included in the time-series data is removed by filtering or comparing with a threshold. Integrating a stiffness matrix can enhance specific moments included in the time-series data. The threshold, filter, or stiffness matrix for the correction may be prepared for each object.

The training device 40 selects a plan level to which the processed time-series data is input (step S22d). Various processing is performed until the final operation of the robot arm 11 is determined. For example, the recognition of the object, the calculation of the task plan, the calculation of the motion plan, the calculation of the gripping plan, etc., are performed. Step S22d selects the level to which the time-series data is input. Subsequently, the time-series data is utilized to train the second policy at the selected plan level.

As a specific example, a gripping plan, a motion plan, a task plan, and a release plan are generated as shown in FIG. 8 when generating some operation. When generating the motion plan and the release plan, the position and force are determined for a relatively short time period. When generating the gripping plan and the task plan, the behavior is determined for a relatively long time period. For example, examples of a behavior over a long time period include gripping after a shifting operation is performed, etc. Step S22d selects whether to utilize the time-series data of some behavior to generate a plan for a relatively short time period or to generate a plan for a relatively long time period. For example, by designating the control cycle for the time-series data, it can be selected whether to utilize the time-series data to generate a plan for a short time period or to generate a plan for a long time period. As an example, the control cycle is set to 1 millisecond when the time-series data is utilized to generate a plan for a short time period. The control cycle is set to 10 milliseconds when the time-series data is utilized to generate a plan for a long time period.

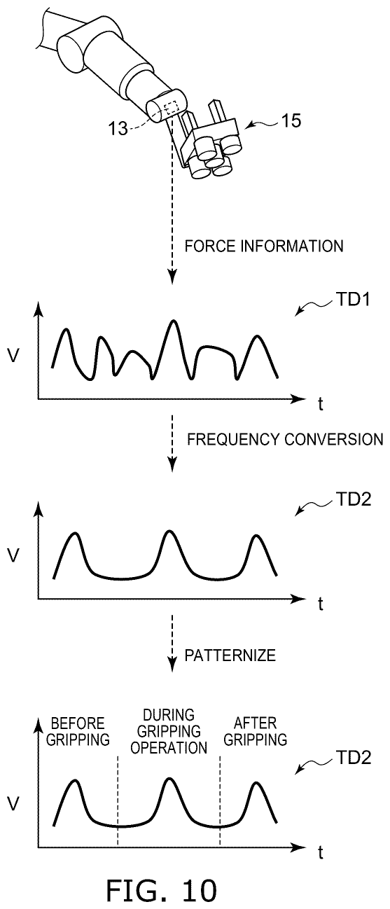

FIG. 10 is a schematic view showing the processing method shown in FIG. 9.

First, time-series data TD1 of force information is acquired from the sensor 13. In the time-series data TD1, the horizontal axis is a time t, and the vertical axis is a detected value v of a sensor. Frequency conversion of the time-series data TD1 is performed to obtain time-series data TD2. By patternizing the time-series data TD2, each timing in the time-series data TD2 is classified as the operation that is being performed.

For example, previous force information when the gripping operation was successful is referred to when the gripping operation fails. The training device 40 trains the second policy so that the force information of the failure approaches the force information of the success. The success rate of the gripping that uses the output from the second policy can be improved thereby.

As an example, an object is gripped by suction. There are cases where an object is dropped while lifting after the gripping, even though the degree of vacuum is sufficiently high. According to the embodiment, the force information and the posture information at the start of the lifting is acquired; and the lift operation is stopped when the object is likely to be dropped. The gripping technique is then switched from suction-gripping to pinching. As a result, the dropping of objects can be avoided.

As another example, a cylindrical or spherical object is gripped by suction. If there is a distance measurement error of the sensor 20, a position calculation error in the plan, etc., there are cases where rolling of the object causes the position of the gripper 15 to shift when the gripper 15 grips the object. According to the embodiment, when the position of the gripper 15 is misaligned, the misalignment can be detected, and the gripper 15 can be moved in the opposite direction of the misalignment. The success rate of the gripping of the circular columnar or spherical object can be increased thereby.

In the second training, information (force information, etc.) of the gripping operation of the handling robot 10 in reality is continuously input to the second policy P2. According to the second policy P2, the suction-gripping operation, the pinching operation, the re-contacting operation, etc., are switched according to the levels of the rewards in an arbitrary state. Teaching data can be obtained by acquiring an image and the grip information output from the second policy P2 at each timing during the operation of the handling robot 10. The image and the grip information are used to train the first model M1. As a result, the first model M1 is trained to output the appropriate grip information at each timing during the operation of the handling robot 10.

After training the first model M1, images that are acquired during the operation of the handling robot 10 are sequentially input to the first model M1. As a result, the appropriate grip information at each timing can be acquired from the first model M1. By reflecting the grip information in the plan, it is possible to stop the lift operation described above and modify the gripping technique. Or, the gripper 15 can be moved in the opposite direction of the misalignment.

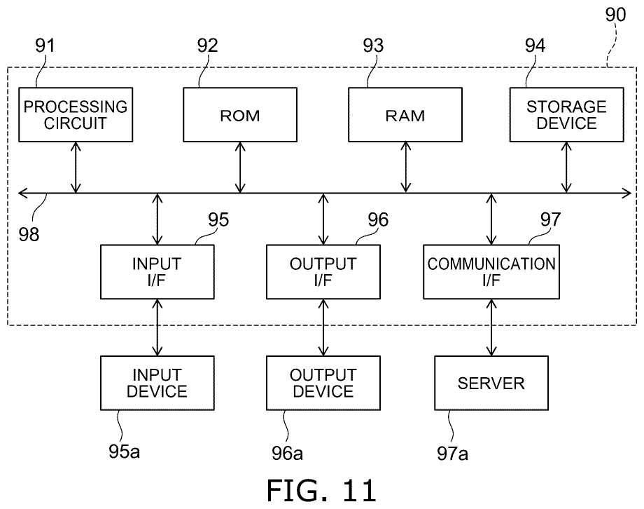

FIG. 11 is a schematic view illustrating a hardware configuration.

For example, a computer 90 shown in FIG. 11 is used as the processing device 30 or the training device 40. The computer 90 includes a processing circuit 91, ROM 92, RAM 93, a storage device 94, an input interface 95, an output interface 96, and a communication interface 97.

The ROM 92 stores programs controlling operations of the computer 90. The ROM 92 stores programs necessary for causing the computer 90 to realize the processing described above. The RAM 93 functions as a memory region into which the programs stored in the ROM 92 are loaded.

The processing circuit 91 includes an arithmetic processor such as a CPU, a GPU, etc. The processing circuit 91 uses the RAM 93 as work memory to execute the programs stored in at least one of the ROM 92 or the storage device 94. When executing the programs, the processing circuit 91 executes various processing by controlling configurations via a system bus 98.

The storage device 94 stores data necessary for executing the programs and/or data obtained by executing the programs.

The input interface (I/F) 95 can connect the computer 90 and an input device 95a. The input I/F 95 is, for example, a serial bus interface such as USB, etc. The processing circuit 91 can read various data from the input device 95a via the input I/F 95.

The output interface (I/F) 96 can connect the computer 90 and an output device 96a. The output I/F 96 is, for example, an image output interface such as Digital Visual Interface (DVI), High-Definition Multimedia Interface (HDMI (registered trademark)), etc. The processing circuit 91 can transmit data to the output device 96a via the output I/F 96 and cause the output device 96a to display an image.

The communication interface (I/F) 97 can connect the computer 90 and a server 97a outside the computer 90. The communication I/F 97 is, for example, a network card such as a LAN card, etc. The processing circuit 91 can read various data from the server 97a via the communication I/F 97.

The storage device 94 includes at least one selected from a hard disk drive (HDD) and a solid state drive (SSD). The input device 95a includes at least one selected from a mouse, a keyboard, a microphone (audio input), and a touchpad. The output device 96a includes at least one selected from a monitor, a projector, a printer, and a speaker. A device such as a touch panel that functions as both the input device 95a and the output device 96a may be used.

The processing that is performed by the processing device 30 or the training device 40 may be realized by one computer 90 or may be realized by collaboration of multiple computers 90. One computer 90 may include the functions of both the processing device 30 and the training device 40.

The processing of the various data described above may be recorded, as a program that can be executed by a computer, in a magnetic disk (a flexible disk, a hard disk, etc.), an optical disk (CD-ROM, CD-R, CD-RW, DVD-ROM, DVD+R, DVD+RW, etc.), semiconductor memory, or another non-transitory computer-readable storage medium.

For example, the data of the recording medium is read by a computer (or an embedded system). The recording format (the storage format) of the recording medium is arbitrary. For example, the computer reads a program from the recording medium and causes a CPU to execute instructions based on the program. The computer may acquire (or read) the program via a network.

According to the embodiments above, a training device, a handling system, a training method, a program, and a storage medium are provided in which the training cost can be reduced.

In the specification, “or” means that “at least one” of the components listed in the text can be employed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention. Moreover, above-mentioned embodiments can be combined mutually and can be carried out.

What is claimed is:

1. A training device, configured to perform at least:
a first training that includes training a first policy in a simulation environment, the first policy being configured to determine a gripping operation of a robot arm including a gripper;
a second training that includes training a second policy in a real environment, the second policy being configured to determine the gripping operation of the robot arm; and
a third training that includes training a model configured to output, according to an input of an image, grip information for gripping an object,
the second training including training the second policy by using
an output from the first policy that is trained, and
sensor information acquired by a sensor in the gripping operation,
the third training including training the model by using, as teaching data,
a first image of a first environment of reality, and
grip information output from the second policy that is trained for the first environment.

2. The training device according to claim 1, wherein
the first training includes training a plurality of the first strategies,
one of the plurality of first strategies is related to an operation of the robot arm when gripping an object, and
another of the plurality of first strategies is related to an operation of the robot arm before gripping the object.

3. The training device according to claim 2, wherein
the second training includes training the second policy by using outputs of the plurality of first strategies.

4. The training device according to claim 1, wherein
first information and second information are input to the first policy in the first training,
the first information includes at least one selected from the group consisting of information of a state of the robot arm, information of a state of a periphery of the robot arm, and information of a behavior of the robot arm, and
the second information includes at least one selected from the group consisting of information of a characteristic of an object to be gripped, information of a characteristic of the gripper, sensor information acquired by a sensor located in the robot arm, and image information of the object to be gripped.

5. The training device according to claim 4, wherein
the second information is input to the first policy after being dimensionally compressed by an encoder.

6. The training device according to claim 1, wherein
the sensor information of the second training includes at least one selected from the group consisting of a load on the gripper, an acceleration of the gripper, and a torque on the gripper.

7. The training device according to claim 1, wherein
the second policy outputs:
a position of the gripper; and
a gripping point indicating a posture of the gripper, and
the third training includes training the model by using, as teaching data, the gripping point output by the second policy.

8. A handling system, comprising:
the training device according to claim 1; and
a handling robot including the robot arm.

9. A training method, comprising:
causing a computer to perform at least
a first training that trains a first policy in a simulation environment, the first policy being configured to determine a gripping operation of a robot arm including a gripper,
a second training that includes training a second policy in a real environment, the second policy being configured to determine the gripping operation of the robot arm, and
a third training that includes training a model configured to output, according to an input of an image, grip information for gripping an object,
the second training including training the second policy by using
an output from the first policy that is trained, and
sensor information acquired by a sensor in the gripping operation,
the third training including training the model by using, as teaching data,
a first image of a first environment of reality, and
grip information output from the second policy that is trained for the first environment.

10. A non-transitory computer-readable storage medium, configured to:
store a program,
the program, when executed by a computer, causing the computer to perform the training method according to claim 9.
